(19) United States
(12) Patent Application Publication
(10) Pub. No.: US 2024/0313486 A1
(43) Pub. Date: Sep. 19, 2024

(54) Wire Connection Device

(71) Applicant: SHENZHEN CHENBEI TECHNOLOGY CO., LTD., SHENZHEN (CN)

(72) Inventors: Lilai Zuo, SHENZHEN (CN); MiaoSheng Wu, SHENZHEN (CN); ZuXiang Chen, SHENZHEN (CN)

(73) Assignee: SHENZHEN CHENBEI TECHNOLOGY CO., LTD., SHENZHEN (CN)

(21) Appl. No.: 18/541,383

(22) Filed: Dec. 15, 2023

(30) Foreign Application Priority Data
Mar. 16, 2023 (CN) CN202320644674.X

(51) Int. Cl. H01R 13/688; A47J 37/06; H01H 85/143; H01H 85/17

(52) U.S. Cl. CPC H01R 13/688; A47J 37/0641; H01H 85/143; H01H 85/17

(57) ABSTRACT

The present application discloses a wire connection device and a cable guard of a cooking appliance. The wire connection device of the cooking appliance includes a fuse, a first end used to connect to an internal wire of the cooking appliance and a second end used to connect to a power cord of the cooking appliance, and a fire-resistant sleeve, being sleeved over the fuse and the first and second ends of the fuse. Further, the fuse is disposed between the internal wire and the power cord of the cooking appliance to prevent a short-circuit fire at the wire connection. The fire-resistant sleeve is sleeved over the outer surface of the wire connection to protect the fuse, the connection between the fuse and the internal wire, and the connection between the fuse and the power cord, which prevents the wire connection from catching fire.

### CROSS-REFERENCE TO RELATED APPLICATIONS

This application claims priority to and benefit of the earlier Chinese Patent Application No. CN202320644674.X filed on Mar. 16, 2023, the content of which is incorporated herein by reference in its entirety.

### TECHNICAL FIELD

The present application belongs to the field of wire connection technology, particularly relating to a wire connection device and a cable guard of a cooking appliance, and a cooking appliance.

### BACKGROUND

The internal wiring of a cooking appliance generally needs to be connected to an external power supply through an external power cord. However, the connection between the power cord and the internal wire of the cooking appliance is prone to short circuit during use, making the circuit resistance too high, resulting in a high temperature that could cause the circuit to catch fire and create a fire hazard.

### BRIEF DESCRIPTION OF THE FIGURES

These and other features and advantages of the present disclosure will become appreciated, as the same becomes better understood with reference to the specification, claims and drawings herein.

FIG. 1 is a structural schematic perspective view of a wire connection device provided by an example of the present application;

FIG. 2 is a structural schematic exploded view of a cable guard provided in an example of the present application;

FIG. 3 is a partial structural schematic view of a cable guard provided in an example of the present application;

FIG. 4 is a partially enlarged schematic view at A in FIG. 3;

FIG. 5 is a partial structural schematic view of the cable guard in FIG. 3 from another perspective;

FIG. 6 is a structural schematic cross-sectional view of a cooking appliance provided in an example of the present application.

### SUMMARY OF THE INVENTION

The purpose of the present application is to address at least one of the existing technical problems in prior art. To this end, the present application proposes a wire connection device and a cable guard of a cooking appliance to prevent a short-circuit fire at the connection between the internal wire and the power cord of the cooking appliance.

In a first aspect, the present application provides a wire connection device of a cooking appliance, including:
a fuse with a first end that connects to an internal wire of the cooking appliance and
a second end that connects to a power cord of the cooking appliance; and,
a fire-resistant sleeve that is sleeved over the outer surface of the fuse and the first and second ends of the fuse.

According to the wire connection device of the present application, the fuse is located between the internal wire of the cooking appliance and the power cord disposed on the cooking appliance, which causes the fuse to blow out in the event of a short circuit to prevent a short circuit at the wire connection. The fire-resistant sleeve, which is sleeved over the outer surface of the wire connection, protects the fuse, the connection between the fuse and internal wire, and the connection between the fuse and the power cord. Thus, even in the case of a short circuit, the fire-resistant sleeve prevents the wire connection from catching on fire.

According to an example of the present application, the fire-resistant sleeve has at least two tightening positions, which are disposed outside the first end and the second end of the fuse, and the flow cross-sectional area between the tightening positions and the outside is smaller than the flow cross-sectional area in the middle portion of the fire-resistant sleeve.

According to an example of the present application, the wire connection device of the cooking appliance further includes:
at least two tightening members, surrounding the outside of the fire-resistant sleeve and disposed at the two corresponding tightening positions, the tightening members can contract inwardly.

According to an example of the present application, the tightening members are disposed as strips, and the distance between the tightening members and the end of the fire-resistant sleeve is more than twice the width of the tightening members.

According to an example of the present application, the wire connection device of the cooking appliance further includes:
a metal strip, which connects the first end of the fuse to the internal wire and connects the second end of the fuse to the power cord.
According to an example of the present application, the fire-resistant sleeve may be made of materials such as glass fibers.

In a second aspect, the present application provides a cable guard of a cooking appliance, including:
a wire connection device according to any of the above, for connecting the internal wire of the cooking appliance and the power cord of the cooking appliance;
a cord protector, provided with a first port and a second port, with the internal wire extending into the cord protector from the first port, the power cord extending into the cord protector from the second port, and the wire connection device being installed in the cord protector;
at least one port is provided with a first limiting structure, which secures the internal wire or the power cord.

According to the cable guard of the present application, the internal wire and the power cord are connected by the wire connection device, which is further protected the cord protector, which receives the connection of the internal wire and the power cord, so as to prevent the cooking appliance from bending and deforming during use, thereby causing short circuit, and to improve safety performance. The first limiting structure secures the internal wire or the power cord to prevent the wiring from escaping from the first port or the second port, further improving the safety performance.

According to an example of the present application, a second limiting structure is provided in the cord protector, and the second limiting structure secures the internal wire or the power cord.

According to an example of the present application, the first and second limiting structures define a clamping gap having an inner diameter that is smaller than the outer diameter of the wire connection device.

According to an example of the present application, the first and second limiting structures include a buckle that is spaced apart from a first side wall of the cord protector, and the power cord and the internal wire are arranged between the buckle and the first side wall.

According to an example of the present application, the first side wall is provided with a convex rib that mates with the first limiting structure or the second limiting structure to abut against at least one of the power cord and the internal wire.

According to an example of the present application, the convex rib is provided with a guide surface at one end away from the bottom wall of the cord protector.

The present application provides an embodiment incorporated into a cooking appliance, including:
a casing;
an electronic device, disposed within the casing;
an internal wire, for connecting to the electronic device;
a power cord, for connecting to an external power source;
the cable guard of the cooking appliance according to any of the above, the cable guard being disposed within the casing, the internal wire extending from the first port into the cord protector, the power cord extending from the second port into the cord protector, and the internal wire and the power cord being connected by the wire connection device.

According to the cooking appliance of the present application, by disposing the cable guard within the cooking appliance, the wire connection between the internal wire and the power cord is provided in the cord protector, and secured therein to prevent the wire connection from bending and deformation, which reduces the risk of a short circuit fire, and improves the safety performance and service life of the cooking appliance.

According to an example of the present application, the cooking appliance further includes:
a motor frame, disposed within the casing;
a direct current (DC) motor, provided on an underside of the motor frame;
a fan, dynamically coupled and connected to the DC motor.
An example of the cooking appliance is an air fryer.

Additional aspects and advantages of the present application will be provided in part in the following description, which will become apparent from the following description, or learned through practice of the present application.

### DETAILED DESCRIPTION

The present invention will be described with reference to the accompanying drawings, in which exemplary embodiments of the present invention are shown. It is noted that, in the accompanying drawings, the same components are denoted by the same reference numerals as possible. In addition, detailed descriptions of well-known functions and configurations that may obscure the subject matter of the present invention will be omitted.

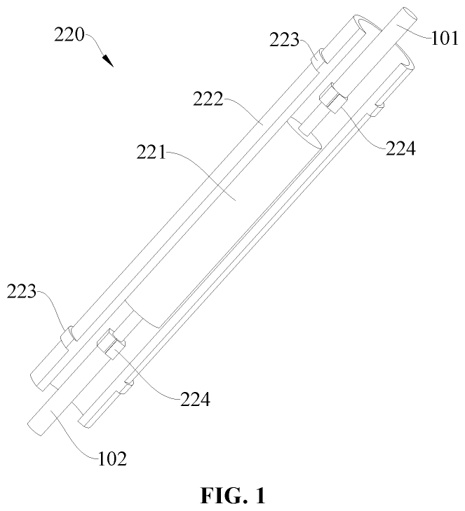

A wire connection device 220 of a cooking appliance according to an example of the present application is described below with reference to FIGS. 1-5.

As shown in FIG. 1, in the present embodiment, the wire connection device 220 of the cooking appliance includes a fuse 221 and a fire-resistant sleeve 222.

A first end of the fuse 221 is used to connect to the internal wire 102 of the cooking appliance and a second end of the fuse 221 is used to connect to the power cord 101 of the cooking appliance.

The fuse 221 is provided with a melt in the middle section. Once the internal wire 102 and the power cord 101 short circuit, the resistance and heat of the circuit become too high. When the heat exceeds the limit of the melt, the melt blows out and the wiring is disconnected, which effectively prevents the internal wire 102 and the power cable 101 from a short circuit and heating, which may result in a fire caused by the increasing wiring temperature.

A fire-resistant sleeve 222 is sleeved over the fuse 221 and the first and second ends thereof.

The fire-resistant sleeve 222 is made of a fireproof material that effectively insulates heat and is non-flammable and non-combustible.

Sleeving the fire-resistant sleeve 222 over the fuse 221, and the first and second ends thereof prevents fires due to the failure of the fuse 221, and prevents open flames due to excessive heat before the fuse 221 blows out.

The fuse 221 is disposed between the power cord 101 and the internal wire 102, which resolves the issue of the power cord 101 and the internal wire 102 being prone to short circuit. In turn, a fire-resistant sleeve 222 is sleeved over the fuse 221, the connection between the fuse 221 and the power cord 101, and the connection between the fuse 221 and the internal wire 102, which protects the areas that may have a risk of fire, and prevents abnormal heating and fire caused by short circuit or abnormal circuit, thereby achieving the technical effect of effectively avoiding short circuit or abnormal fire at the wire connection in the cooking appliance.

According to the wire connection device 220 provided in an example of the present application, a fuse 221 is disposed between the internal wire 102 disposed on the cooking appliance and the power cord 101 disposed on the cooking appliance to prevent short-circuit fire at the wire connection; the fire-resistant sleeve 222 is disposed to be sleeved over the outer surface of the wire connection to protect the fuse 221, the connection between the fuse 221 and internal wire 102, and the connection between the fuse 221 and the power cord 101, which prevents fire even in the case of a short circuit and heating, thereby further preventing the wire connection from catching fire.

As shown in FIG. 1, in some examples, the fire-resistant sleeve 222 has at least two tightening positions, two of which are provided outside the first and second ends of the fuse 221.

The fire-resistant sleeve 222 at the tightening positions is contractible inwardly to reduce the gap between the fire-resistant sleeve 222 and the internal wire 102 thereof, thereby reducing the air circulation at the tightening positions. By disposing two tightening positions, an insulated space may be formed between the two tightening positions to reduce the contact and circulation between the inside of the insulated space and the external air.

It should be noted that the two tightening positions are provided outside the first and second ends of the fuse 221, which refer to the length direction of the sleeve. The first and second ends of the fuse 221 are located between the two tightening positions, so as to fully insulate the wire connection in the insulated space. Even if a short circuit causes an open flame, the fire will not spread further due to the lack of air circulation and lack of oxygen, which prevents combustion.

The present embodiment has at least two tightening positions, and the plurality of tightening positions may be in the form of at least one of the following structures:
first, two tightening positions are provided, and they are located on the outer surface of the wire connection between the fuse 221 and internal wire 102, and the connection between the fuse 221 and the power cord 101;
second, more than two tightening positions are provided, and the more than two tightening positions are evenly disposed on the outer surface of the wire connection between the fuse 221 and the internal wire 102, and the connection between the fuse 221 and the power cord 101, so as to enhance the insulation effect by disposing more tightening positions;
third, more than two tightening positions are provided, at least two of which are evenly provided on the outer surface of the wire connection between the fuse 221 and internal wire 102, and the connection between the fuse 221 and the power cord 101 to ensure insulation, of which at least one tightening position is provided at the fuse 221 to secure the position of the fuse 221 in the fire-resistant sleeve 222 to avoid radial shaking from affecting the connection between the fuse 221 and the internal wire 102, and the connection between the fuse 221 and the power cord 101.

In the present embodiment, the flow cross-sectional area between the tightening position and the outside is smaller than the flow cross-sectional area in the middle portion of the fire-resistant sleeve 222.

The flow cross-sectional area between the tightening position and the outside is the gap cross-sectional area between the fire-resistant sleeve 222 and the internal wire 102 thereof at the tightening position, the flow cross-sectional area at the middle portion of the fire-resistant sleeve 222 is the flow cross-sectional area at the fuse 221, the middle portion of the fire-resistant sleeve 222 has a greater cross-sectional area to accommodate the fuse 221, and the tightening position has a smaller flow cross-sectional area to effectively insulate air.

It can be understood that the smaller the flow cross-sectional area between the tightening position and the outside, the better the insulation effect.

In some examples, the flow cross-sectional area of the tightening position and the outside and the flow cross-sectional area of the middle portion of the fire-resistant sleeve 222 is a ratio α, where α<1/5, α=1/10, α=1/15, or α=1/20.

According to the fire-resistant sleeve 222 provided in the present example, contact between the internal wire connection and external air is insulated through the thermal insulation and flame retardation properties of the fire-resistant sleeve 222 and the disposition of the tightening position. Even in the case of an open flame, the fire will not spread further. Hence, the fire-resistant sleeve is effective in insulation.

In some examples, the wire connection device 220 of the cooking appliance further includes at least two tightening members 223, surrounding the outside of the fire-resistant sleeve 222 and disposed at the two corresponding tightening positions, the tightening members 223 being disposed to be contractible inwardly.

As shown in FIG. 1, the tightening position contracts inwardly by disposing tightening members 223 on the outer surface of the tightening position. The tightening members 223 surround the outside the fire-resistant sleeve 222 such that the tightening position has no contraction blind spots during contraction.

In which, the tightening members 223 may be disposed in the form of at least one of the following structures:
first, the tightening members 223 are cable ties, and during installation, the cable ties are pulled tightly around the tightening position to achieve the contraction of the fire-resistant sleeve 222, which is simple to operate;
second, the tightening members 223 are metal bindings, and during installation, the metal bindings are pulled tightly around the tightening position and do not loosen due to the high heat resistance and strength of metal; it can be understood that there are no restrictions on the material of the metal bindings, and they may be iron, copper, and the like.

Disposing the tightening members 223 may also secure the relative position of the fire-resistant sleeve 222 to the wiring to prevent the fire-resistant sleeve 222 from moving along the wiring, resulting in the fuse 221, the connection between the fuse 221 and the internal wire 102, or the connection between the fuse 221 and the power cord 101 escaping from the scope of protection of the fire-resistant sleeve 222.

In some examples, the tightening members 223 are adapted to face the jacket portion of the power cord 101.

In the present embodiment, the jacket of the power cord 101 is the outermost protective skin of the power cord 101. The jacket of the power cord 101 is larger in diameter and stronger. The tightening members 223 are disposed at the jacket of the power cord 101, and the tightening members 223 are tightened on the jacket of the power cord 101 to secure it further. Moreover, due to the small contraction stroke, the fire-resistant sleeve 222 deforms to a small degree. Hence, it has a better fit and sealing effects.

It can be understood that if the internal wire 102 is also provided with a jacket, the tightening member 223 located on one side of the internal wire 102 is also correspondingly disposed at the jacket of the internal wire 102.

As shown in FIG. 1, in some examples, the tightening members 223 are disposed as strips.

The tightening strips are disposed to be strips, with a larger contact surface with the fire-resistant sleeve 222 during tightening, have better tightening effects and are less prone to wear and tear.

In the present embodiment, the distance between the tightening members 223 and the end of the fire-resistant sleeve 222 is greater than 2 times the width of the tightening members 223.

In the present embodiment, as the fire-resistant sleeve 222 is not made of a rigid material, the tightening members 223 are spaced a certain distance from the end of the fire-resistant sleeve 222 such that the contact between the tightening members 223 and the fire-resistant sleeve 222 is more secure, preventing the tightening members 223 from falling off the fire-resistant sleeve 222 when they are too close the end of the fire-resistant sleeve 222.

As shown in FIG. 1, in some examples, the wire connection device 220 of the cooking appliance further includes metal strips 224, which connect the first end of the fuse 221 to the internal wire 102 and connects the second end of the fuse 221 to the power cord 101.

By disposing the metal strips 224 to connect the fuse 221 to the internal wire 102, and the fuse 221 to the power cord 101, the connection structure is more stable and does not come off easily.

It should be noted that in order to avoid affecting the conductive properties, the metal material of the metal strips 224 is a conductive metal material. The specific material is not limited hereto. The metal strips 224 may be made of materials such as copper material and aluminum material.

In some examples, the fire-resistant sleeve 222 may be made of materials such as glass fibers.

It should be noted that the specific materials of the fire-resistant sleeve 222 are not limited hereto. According to the actual requirements, the fire-resistant sleeve may be in the following forms, in ascending order of heat resistance: high temperature-resistant sleeve made of pure glass fiber, high temperature-resistant sleeve made of silicone glass fiber, basalt flame-retardant high temperature-resistant sleeve, and high silica fireproof and high temperature-resistant sleeve.

In some examples, at least two fuses 221 and fire-resistant sleeves 222 are provided, respectively, which correspond to the neutral wire and live wire of the internal wire 102 and the power cord 101, respectively.

In which, the first end of one of the two fuses 221 is used to connect to the neutral wire of the internal wire 102, the second end of one of the two fuses 221 is used to connect to the neutral wire of the power cord 101, the first end of the other of the two fuses 221 is used to connect to the live wire of the internal wire 102, and the second end of the other of the two fuses 221 is used to connect to the live wire of the power cord 101.

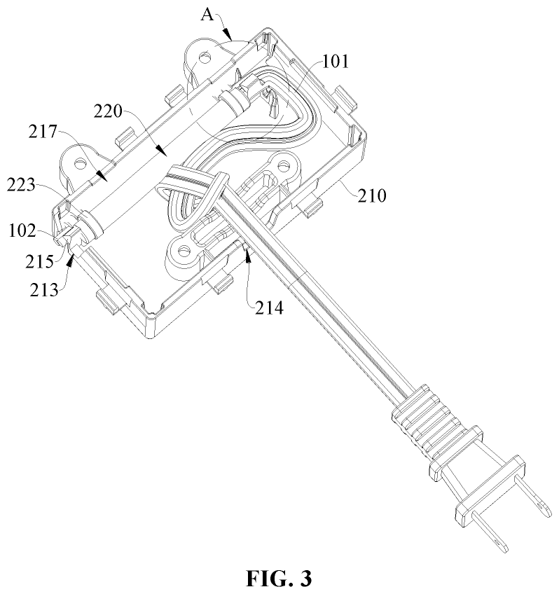

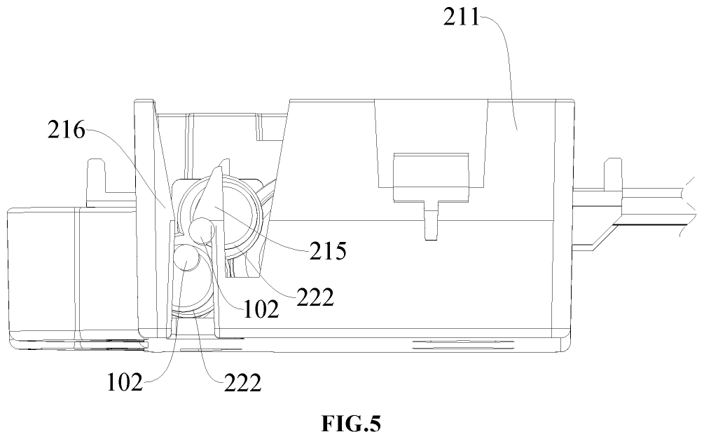

As shown in FIGS. 3 and 5, since the power cord 101 generally includes a neutral wire and a fire wire, at least two fuses 221 and fire-resistant sleeves 222 are provided, respectively, to correspond to the connection disposed at the neutral wire and the connection disposed at the live wire.

In some cooking appliances, the power cord 101 may be three-phase wire, at which point three fuses 221 and fire-resistant sleeves 222 are provided, respectively, to connect to the three-phase wires, respectively.

It may be understood that there is no limit to the number of fuses 221 and fire-resistant sleeves 222. According to the number of phases of power supply required by the cooking appliance, several fuses 221 and fire-resistant sleeves 222 are provided to connect the various wiring, respectively.

Embodiments of the present application also provide a cable guard 200 of a cooking appliance.

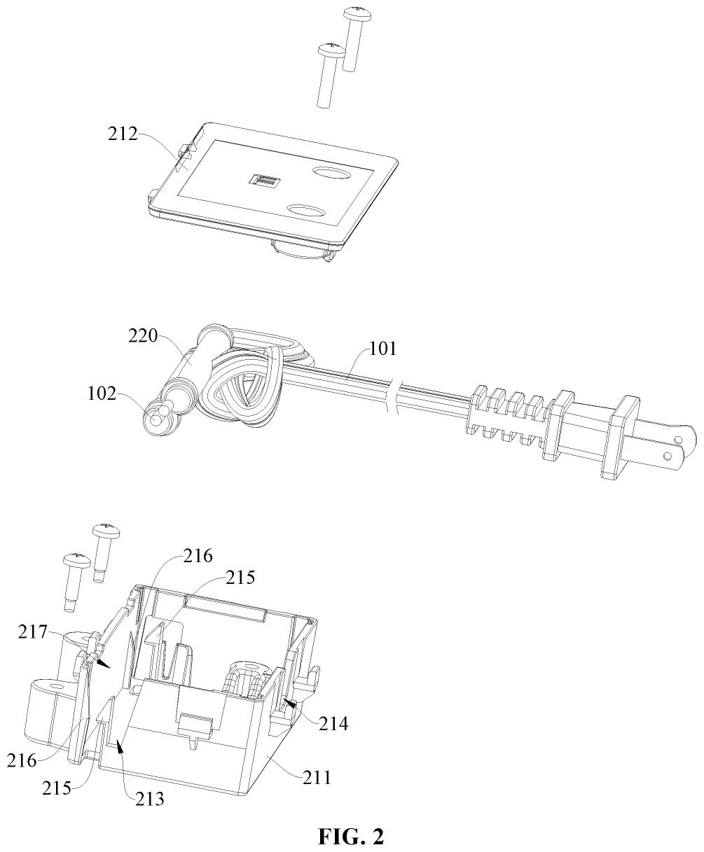

As shown in FIGS. 2-5, in the present embodiment, the cable guard 200 of the cooking appliance includes a wire connection device 220 and a cord protector 210.

In the present embodiment, the wire connection device 220 is the wire connection device 220 according to any of the above, so it will not be described herein. The wire connection device 220 is used to connect the internal wire 102 of the cooking appliance to the power cord 101 of the cooking appliance.

In the present embodiment, the cord protector 210 is provided with a first port 213 and a second port 214, the internal wire 102 is used to extend into the cord protector 210 from the first port 213, and the power cord 101 is used to extend into the cord protector 210 from the second port 214.

As shown in FIG. 2, the cord protector 210 is provided with a bottom casing 211 and a top cover 212, and the first and second ports 213, 214 are provided on the side walls of the bottom casing 211. Moreover, the first and second ports 213, 214 are provided with a top opening. During installation, the top cover 212 may be taken down and the internal wire 102 and power cord 101 may be placed in directly, which is simple to operate.

In the present example, at least one of the first port 213 and the second port 214 is provided with a first limiting structure, which secures the internal wire 102 or the power cord 101.

By disposing the first limiting structure, the internal wire 102 or the power cord 101 is secured in place to limit the wiring at the entrance, improve the wiring stability, and prevent the internal wire 102 or the power cord 101 from shaking or moving, which may easily lead to disengagement at the wire connection, and may also prevent the wire connection device 220 from escaping the cord protector 210 to further improve the safety performance.

In which, the first limiting structure may be disposed in the form of at least one of the following structures:
first, the first limiting structure is disposed at the first port 213 to limit the internal wire 102 passing through the first port 213;
second, the first limiting structure is disposed at the second port 214 to limit the power cord 101 passing through the second port 214;
third, two first limiting structures are disposed at the first port 213 and the second port 214, respectively, and the internal wire 102 and the power cord 101 are simultaneously limited.

According to the cable guard 200 provided by the present example, by disposing the cord protector 210 to receive the connection between the internal wire 102 and the power cord 101, the connection between the power cord 101 and the internal wire 102 is secured in the cord protector 210, first preventing external compression of the connection, and limiting the internal wire 102 or the power cord 101 through the first limiting structure to prevent the cooking appliance from dragging the power cord 101 or the internal wire 102 during use or when the worker installs the connection, causing the wire connection device 220 to bend and deform and cause a short circuit, and prevent the wire connection device 220 from escaping the cord protector 210, thereby improving the safety performance.

As shown in FIGS. 2-5, in some examples, a second limiting structure is provided in the cord protector 210, and the second limiting structure secures the internal wire 102 or the power cord 101.

In the present embodiment, the second limiting structure secures the internal wire 102 or the power cord 101 located inside the cord protector 210 in place.

Based on the above disposition method of the first limiting structure, the second limiting structure may be embodied in the following ways, accordingly:
first, when the first limiting structure is only disposed at the first port 213, the second limiting structure limits the power cord 101;
second, when the first limiting structure is only disposed at the second port 214, the second limiting structure limits the internal wire 102;
third, when two first limiting structures are disposed at the first port 213 and the second port 214, respectively, the second limiting structure is disposed according to the position of the wire connection device 220, refer to the following examples for illustration:
   in an example, the wire connection device 220 is located in the middle portion of the cord protector 210, and two second limiting structures may be disposed at both ends of the wire connection device 220;
   in another example, the wire connection device 220 is disposed proximate to the first port 213, and the second limiting structure limits the power cord 101; in yet another example, the wire connection device 220 is disposed proximate to the second port 213, and the second limiting structure limits the internal wire 102.

In the present embodiment, the first limiting structure and the second limiting structure are used to define both ends of the wire connection device 220, respectively. After the two limiting structures limit both ends of the wire connection device 220, the wire connection device 220 is kept in a straight state to prevent the fuse 221 from bending or the connection between the fuse 221 and the internal wire 102, and the connection between the fuse 221 and the power cord 101 from bending.

In the present embodiment, the ratio of the spacing between the two limiting structures to the length of the wire connection device 220 is ß, where 1≤ ß≤1.1.

In the present embodiment, the two limiting structures are disposed in the following two ways:
in an example, β=1, the spacing between the two limiting structures is equal to the length of the wire connection device 220 such that the fire-resistant sleeve 222 is stuck between the two limiting structures when the wire connection device 220 is installed, so as to prevent the fire-resistant sleeve 222 from moving axially and to secure it;
in another example, 1<β≤1.1, the spacing between the two limiting structures is slightly larger than the length of the fire-resistant sleeve 222 to facilitate the installation of the wire connection device 220, and at the same time, the activity space of the fire-resistant sleeve 222 is insufficient for the connection between the fuse 221 and the internal wire 102, and the connection between the fuse 221 and the power cord 101 to escape the protection of the fire-resistant sleeve 222.

In some examples, the first and second limiting structures define a clamping gap.

The clamping gap is in the form of a buckle slot with an opening at the top end, which clamps the power cord 101 and the internal wire 102 within the clamping gap to limit the wire connection device 220.

In the present embodiment, the inner diameter of the clamping gap is smaller than the outer diameter of the wire connection device 220.

The inner diameter of the clamping gap is smaller than the outer diameter of the wire connection device 220 such that the wire connection device 220 does not escape from the gap of the clamping gap.

Based on the present example, the size of the clamping gap is disposed in the following two ways:
first, the inner diameter of the clamping gap is greater than or equal to the outer diameter of the power cord 101 or the internal wire 102;
the inner diameter of the clamping gap is larger than the outer diameter of the power cord 101 and the internal wire 102, such that the power cord 101 and the internal wire 102 are clamped in the clamping gap easily for ease of installation; second, the inner diameter of the clamping gap is smaller than the outer diameter of the power cord 101 or the internal wire 102.

By interference fitting the power cord 101 or the internal wire 102 with the clamping gap, the power cord 101 or the internal wire 102 does not escape easily after being installed into the clamping gap, which prevents loosening and improves installation stability.

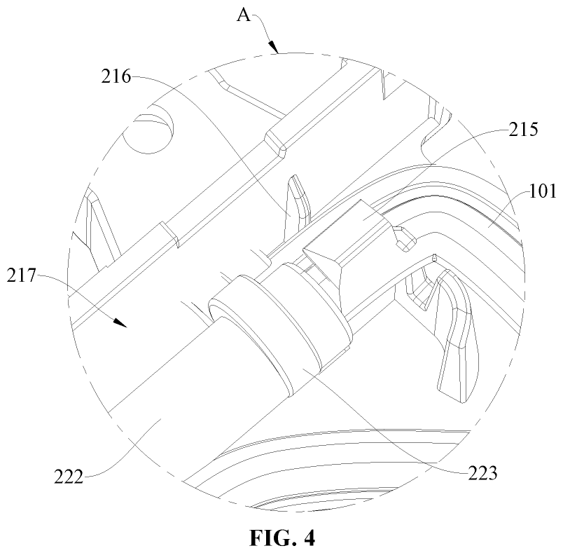

Based on the above embodiment, the clamping gap may be disposed in a variety of ways:
first, the clamping gap is formed by providing a groove on the bottom wall of the cord protector 210:
in some examples, two coaxial grooves disposed with axial spacing are provided on the bottom wall of the cord protector 210, the two grooves forming two clamping gaps, and each groove being disposed in the form of a buckle slot such that the power cord 101 and the internal wire 102 are clamped in the buckle slot and do not escape easily; a housing slot is formed between the two clamping gaps, the inner diameter of the housing slot being greater than the internal diameter of the clamping gaps to receive the wire connection device 220;
second, the clamping gap is formed by disposing a buckle 215 and a first side wall 217:
as shown in FIGS. 4 and 5, in some examples, the first limiting structure and the second limiting structure include a buckle 215, the buckle 215 being spaced apart from the first side wall 217 of the cord protector 210, and the power cord 101 and the internal wire 102 being arranged between the buckle 215 and the first side wall 217;
the buckle 215 is disposed on the bottom wall of the cord protector 210, the buckle 215 being disposed to be spaced apart from the first side wall 217 of the cord protector 210 to form a clamping gap between the buckle 215 and the first side wall 217, and the buckle portion of the buckle 215 is disposed towards the first side wall 217;
the power cord 101 and the internal wire 102 are clamped between the buckle 215 and the first side wall 217 to prevent the power cord 101 and the internal wire 102 from moving in the radial direction freely, the buckle portion being capable of preventing the power cord 101 and the internal wire 102 from escaping from the top of the clamping gap, and the wire connection device 220 being disposed along the first side wall 217, with a stable structure.

In some examples, the first side wall 217 is provided with a convex rib 216, which mates with at least one of the first limiting structure or the second limiting structure to abut against at least one of the power cord 101 and the internal wire 102.

The convex rib 216 is disposed to abut against the power cord 101 and the internal wire 102 towards the direction of the buckle 215 and mates with the buckle portion of the buckle 215 to prevent the power cord 101 or internal wire 102 from escaping from the top of the clamping gap.

The convex rib 216 is disposed corresponding to the buckle 215 to ensure the abutment.

As shown in FIGS. 2-4, in the present embodiment, the first port 213 is disposed to be adjacent to the first side wall 217, one of the two buckles 215 is disposed to be proximate to the first port 213, the other buckle 215 is disposed to be inside the cord protector 210, the internal wire 102 may be limited by the mating of the side wall of the first port 213 with the buckle 215, and the convex rib 216 is disposed to correspond to the other buckle 215 to facilitate the limiting of the power cord 101.

In some examples, the convex rib 216 is provided with a guide surface at one end away from the bottom wall of the cord protector 210.

The guide surface corresponds to the position of the buckle portion, and the guide surface is disposed to be gradually proximate to the buckle portion along the depth direction of the clamping gap such that the power cord 101 or the internal wire 102 is easily clamped in the clamping gap by disposing the guide surface to be inclined.

In which, the width of the smallest distance between the guide surface and the buckle portion is smaller than the outer diameter of the power cord 101 or the internal wire 102, which prevents the power cord 101 or the internal wire 102 from escaping from the gap.

In some examples, the cord protector 210 is made of a fireproof material.

Safety hazards are further reduced by disposing the cord protector 210 to be made of a thermal-insulated fireproof material. The specific fireproof material is not limited herein and may be a commonly used fireproof plastic material on the market.

Examples of the present application also provide a cooking appliance.

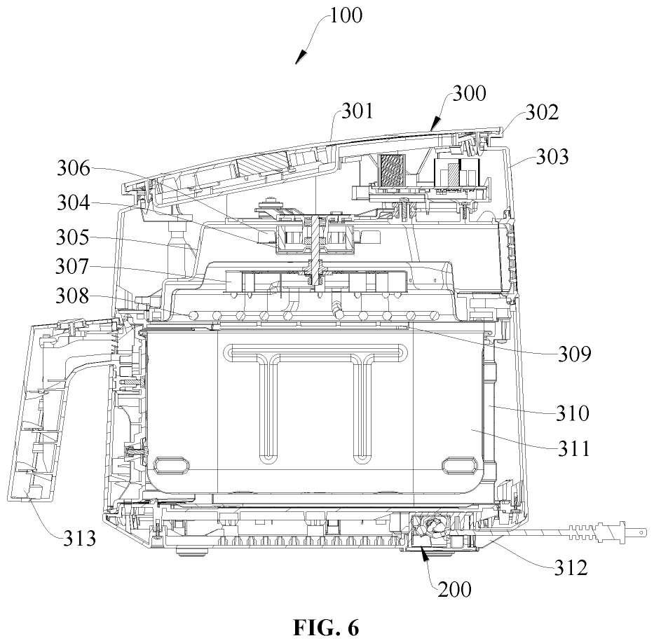

As shown in FIGS. 2 and 6, the cooking appliance includes a casing 100, an electronic device, an internal wire 102, a power cord 101, and the cable guard 200 according to any of the examples above.

The electronic device is disposed within the casing 100, the internal wire 102 is used to connect to the electronic device, and the power cord 101 is used to connect to an external power source.

The cable guard 200 is disposed within the casing 100, the internal wire 102 extends from the first port 213 into the cord protector 210, the power cord 101 extends from the second port 214 into the cord protector 210, and the internal wire 102 and the power cord 101 are connected by the wire connection device 220.

According to the cooking appliance provided in the examples of the application, by disposing a cable guard 200 in the cooking appliance, the wire connection between the internal wire 102 and the power cord is provided in the cord protector 210, and secured therein to prevent the wire connection from bending and deformation, which reduces the risk of short-circuit fire, and improves the safety performance and service life of the cooking appliance.

The disposition of the cord protector 210 is capable of reducing the activity space of the wire connection protection device during transportation and storage, reduce shaking and pulling of the internal wire and power cord. If there is poor contact between the power cord 230 and the contact end of the internal wire 220 during use, producing a flame and high temperatures, the cord protector 210 is capable of preventing air from flowing through the power box, which results in high temperatures and fire, and effectively blows out the fuse and causes a power outage at the wire connection immediately when it reaches a high temperature, preventing a fire and combustion of the prototype.

As shown in FIG. 6, in some examples, the cooking appliance is an air fryer 300.

In the present embodiment, the air fryer includes a motor frame 305, a DC motor 304, and a fan.

The motor frame 305 is provided within the casing, the DC motor 304 is provided on the underside of the motor frame 305, and the DC motor 304 is dynamically coupled and connected to the fan to drive the fan to rotate.

In the present example, the DC motor 304 has a smaller height dimension than an alternating current (AC) motor. By providing the DC motor 304 on the underside of the motor frame 305, it is able to effectively compress the space at the top of the air fryer, reduce the height of the air fryer, and take up less space, so as to facilitate storage and use.

In the present embodiment, the fan includes a cooler blade 306 and a heater blade 307.

The cooler blade 306 is provided on the peripheral side of the DC motor 304, and is capable of achieving high-speed rotation through the shaft connection. The heater blade 307 is placed below the cooler blade 306, and may be connected to the nut through the shaft, so as to achieve high-speed rotation.

By disposing the cooler blade 306 to be around the DC motor 304, the height of the air fryer is further compressed to improve the ease of use of the air fryer while ensuring heat dissipation.

In the present embodiment, the air fryer 300 further includes a top cover 301, a trim ring 302, a machine body 303, a heating tube 308, a guide rail 309, a rim 310, a vat 311, a base 312, a handle 313, and a cord protector 210.

The machine body 303 may be understood to be the casing.

In the present embodiment, the top cover 301 and the trim ring 302 are connected through buckles; the trim ring 302 and the machine body 303 are connected by screws; the motor frame 305 is placed inside the machine body 303, is placed above the guide rail 309, and is connected by screws; and the DC motor 304 is provided on the underside of the motor frame 305, and is connected by screws. An air outlet is disposed on the rear side of the machine body 303 and the motor frame 305, and is connected by buckles; the heating tube 308 is placed below the heater blade 307 and is connected to the motor frame 305 by screws; the guide rail 309 is placed below the motor frame 305 and is connected by screws; the rim 310 is placed below the guide rail 309 and is connected by screws; the base 312 is placed below the rim 310 and the machine body 303, is connected by screws, and form an internal cavity with the motor frame 305 and rim 310; the vat 311 is placed in the internal cavity, the handle is placed on the outer surface of the vat 311, is connected by screws, and the vat 311 is pulled out by pulling the handle 313; the cord protector 210 is placed below the base 312, is connected by screws, and is capable of protecting the circuit.

The terms “first,” “second,” and the like in the Specification and Claims of the present application are used to distinguish similar objects and are not used to describe a particular order or sequence. It should be understood that the data used in this manner may be interchanged where appropriate such that the examples of the present application may be implemented in a sequence other than those illustrated or described herein, and that the objects distinguished by “first”, “second”, and the like. are generally one type and do not define the number of objects, for example, the first object may be one or a plurality. Furthermore, “and/or” in the Specification and Claims refer to at least one of the connected objects, the character “/” and generally the pre- and post-associated object is an “or” relationship.

In the description of the present application, it is to be understood that the orientational or positional relationship indicated by “length”, “width”, “top”, “bottom”, “inner”, “outer”, “clockwise”, “counterclockwise”, “axial”, “radial”, “circumferential”, and the like is based on the orientational or positional relationship shown in the drawings, and is merely for the purpose of describing the present application and simplifying the description, rather than indicating or implying that the device or element referred to must have a specific orientation, be constructed and operated in a specific orientation, and thus cannot be construed as a limitation of the present application.

In the description of the present application, a “first feature”, a “second feature” may include one or a plurality of the features.

In the description of the present application, “plurality” means two or more.

Throughout the description of the present Specification, reference to the terms “an example,” “some examples,” “exemplary examples,” “examples,” “specific examples,” “some examples,” and the like, means that specific features, structures, materials, or characteristics described in connection with the example or implementation are included in at least one example or implementation of the present application. In the present Specification, schematic representations of the above terms are not necessarily meant to refer to the same example or implementation. Moreover, the specific features, structures, materials, or characteristics described may be combined in a suitable manner in any one or a plurality of examples or implementations.

Although examples of the present application have been shown and described, those with ordinary skill in the art may understand that: Various changes, modifications, substitutions and variations may be made to these examples without departing from the principles and purposes of the present application, the scope of which is defined by the Claims and their equivalents.

For ease of reference, the reference numbers in the figure are:
casing 100, power cord 101, internal wire 102; cable guard 200; cord protector 210, bottom casing 211, top cover 212, first port 213, a second port 214, buckle 215, convex rib 216, first side wall 217; wire connection device 220, fuse 221, fire-resistant sleeve 222, tightening member 223, metal strip 224; air fryer 300, top cover 301, trim ring 302, machine body 303, DC motor 304, motor frame 305, cooler blade 306, heater blade 307, heating tube 308, guide rail 309, rim 310, vat 311, base 312, handle 313.

What is claimed is:

1. A wire connection device for a cooking appliance comprising:
a fuse with an outer surface, a first end that connects to an internal wire of the cooking appliance, and a second end that connects to a power cord of the cooking appliance;
a fire-resistant sleeve that encapsulates the outer surface of the fuse and the first and second ends of the fuse.

2. The wire connection device according to claim 1, further comprising
at least two tightening members that encircle the fire-resistant sleeve located on at least two tightening positions near the first end and second end of the fuse, respectively.

3. The wire connection device according to claim 2, wherein the tightening members contract inwardly at said at least two tightening positions such that the cross-sectional area of portion of the fire-resistant sleeve between the tightening positions is smaller compared to the cross-sectional area of the at least two tightening positions when the tightening members are contracted.

4. The wire connection device according to claim 2, wherein the tightening members are strips, and the distance between the tightening members and the end of the fire-resistant sleeve is greater than the width of the tightening members.

5. The wire connection device according to claim 1, further comprising at least two metal strips that connects the first end of the fuse to the internal wire and connects the second end of the fuse to the power cord.

6. The wire connection device according to claim 5, wherein the fire-resistant sleeve may be made of a fire-resistant material.

7. The wire connection device according to claim 6, wherein the fire-resistant material is a glass fiber.

8. The wire connection device according to claim 6, wherein the fire-resistant material is a silicone glass fiber.

9. The wire connection device according to claim 6, wherein the fire-resistant material is a basalt flame-retardant.

10. The wire connection device according to claim 6, wherein the fire-resistant material is silica.

11. The wire connection device according to claim 6, further comprising:
a cord protector wherein the wire connection device is installed in the cord protector;
wherein the cord protector is further comprised of:
a first port and a second port wherein the internal wire of the cooking appliance extends into the first port of the cord protector and the power cord of the cooking appliance extends into the second port of the cord protector;

12. The wire connection device according to claim 11, wherein the cord protector is provided with at least one limiting structure located at either at the first port and/or the second port to secure either the internal wire or the power cord.

13. The wire connection device according to claim 11, wherein the first limiting structure and the second limiting structure define a clamping gap, the inner diameter thereof being smaller than the outer diameter of the wire connection device.

14. The wire connection device according to claim 13, wherein the first and second limiting structures include a buckle that is spaced apart from a first side wall of the cord protector, and the power cord and the internal wire are arranged between the buckle and the first side wall.

15. The wire connection device according to claim 14, wherein the first side wall is provided with a convex rib that mates with the first limiting structure or the second limiting structure to abut against at least one of the power cord or the internal wire.

16. The cable guard of the cooking appliance according to claim 15, wherein the convex rib is provided with a guide surface at one end away from a bottom wall of the cord protector.

17. A wire connection device for a cooking appliance comprising:
a fuse with an outer surface, a first end that connects to an internal wire of the cooking appliance, and a second end that connects to a power cord of the cooking appliance;
a fire-resistant sleeve that encapsulates the outer surface of the fuse and the first and second ends of the fuse;
at least two tightening members that encircle the fire-resistant sleeve located on at least two tightening positions near the first end and second end of the fuse, respectively; wherein the tightening members contract inwardly at said at least two tightening positions such that the cross-sectional area of portion of the fire-resistant sleeve between the tightening positions is smaller compared to the cross-sectional area of the at least two tightening positions when the tightening members are contracted;
a cord protector comprised of a first port and a second port wherein the internal wire of the cooking appliance extends into the first port of the cord protector and the power cord of the cooking appliance extends into the second port of the cord protector; wherein the wire connection device is installed in the cord protector;
wherein the wire connection device is enclosed by a casing for the cooking appliance.

18. The wire connection device according to claim 17, wherein the cooking appliance in which the wire connection device is installed is an air fryer, which further comprises:
a motor frame, disposed within the casing;
a direct current motor, provided on an underside of the motor frame;
a fan, dynamically coupled and connected to the direct current motor.
